(19) United States
(12) Patent Application Publication
(10) Pub. No.: US 2026/0063521 A1
(43) Pub. Date: Mar. 5, 2026

(54) MICROFLUIDIC MANIFOLD AND METHODS OF USE THEREOF

(71) Applicant: University of Louisville Research Foundation, Inc., Louisville, KY (US)

(72) Inventors: Thomas J. Roussell Jr., Louisville, KY (US); Alexa M. Melvin, Louisville, KY (US); Nichola C. Garbett, Louisville, KY (US); Gabriela Schneider, Louisville, KY (US); Andrew P. DeFilippis, Nashville, TN (US)

(21) Appl. No.: 19/320,835

(22) Filed: Sep. 5, 2025

Related U.S. Application Data
(63) Continuation of application No. 17/080,805, filed on Oct. 26, 2020, now Pat. No. 12,442,736.
(60) Provisional application No. 62/925,734, filed on Oct. 24, 2019.

(51) Int. Cl. G01N 1/40; B01D 63/00; B01L 3/00; G01N 1/38

(52) U.S. Cl. CPC G01N 1/4077; B01D 63/005; B01L 3/502761; B01L 3/567; G01N 1/38; B01L 2200/0652; B01L 2300/123; B01L 2300/165; B01L 2400/0605; B01L 2400/086

(57) ABSTRACT

An extraction chamber includes a main channel, a plasma channel, and a plurality of side channels fluidly connecting the main channel to the plasma channel. Each of the plurality of side channels has an average diameter of at most 200 μm at a narrowest cross section, and the extraction chamber has a separation efficiency of at least 95%. A multilevel extraction chamber, includes a main channel, a secondary channel fluidly connected to the main channel, a plasma channel fluidly connected to the secondary channel, a first set of a plurality of side channels fluidly connecting the main channel to the secondary channel, and a second set of a plurality of side channels fluidly connecting the secondary channel to the plasma channel. Each of the first set of side channels has an average diameter that is greater than the average diameter of each of the second set of side channels, and the extraction chamber has a separation efficiency of at least 95%.

### BACKGROUND

The isolation of blood plasma, essentially the extracellular matrix of the larger blood cells, from whole blood is one of the most basic yet vital steps for many diagnostic techniques. The yellowish liquid contains important biomarkers (primarily plasma proteins) that have been shown to provide unique diagnostic and therapeutic characteristics. Liquid plasma is isolated (extracted) from whole blood to remove the larger cellular blood contents (red blood cells, white blood cells, etc.) the presence of which complicates sample analysis and analyte detection

Recent studies have attempted to isolate blood plasma using microfluidic devices. Although several microfluidic devices that extract plasma are found in the literature, few have used undiluted whole blood directly. These microfluidic devices generally suffer from low plasma yield and low separation efficiency, resulting in impure samples that require further processing. Additionally, no studies have diluted extracted plasma directly within a microfluidic device.

### SUMMARY

In a first aspect, the invention is an extraction chamber including a main channel, a plasma channel, and a plurality of side channels fluidly connecting the main channel to the plasma channel. Each of the plurality of side channels has an average diameter of at most 200 μm at a narrowest cross section, and the extraction chamber has a separation efficiency of at least 95%.

In a second aspect, the invention is a multilevel extraction chamber, including a main channel, a secondary channel fluidly connected to the main channel, a plasma channel fluidly connected to the secondary channel, a first set of a plurality of side channels fluidly connecting the main channel to the secondary channel, and a second set of a plurality of side channels fluidly connecting the secondary channel to the plasma channel. Each of the first set of side channels has an average diameter that is greater than the average diameter of each of the second set of side channels, and the extraction chamber has a separation efficiency of at least 95%.

### Definitions

The term “separation efficiency” refers to the percentage of particles present in whole blood that enter the main channel but do not enter the plasma channels of an extraction chamber device. This can also be referred to as “purity”. A separation efficiency is preferably at least 95%, more preferably at least 99%.

All percentages (%) are weight/weight percentages, unless stated otherwise.

“Cellular tissue” refers to cellular blood contents such as red blood cells and white blood cells. Cellular tissue may also be referred to as “cellular contents” or “cellular components”.

“Average diameter” is the diameter of a circle with the same area as the cross-section of the channel including only those parts which allow fluid to flow (that is, reduced by the portion of the channel taken up by an obstruction), and applies even when the cross-section of the channel is not a circle.

### BRIEF DESCRIPTION OF THE DRAWINGS

The invention can be better understood with reference to the following drawings and description.

FIG. 1 illustrates a design of a plasma extraction chamber.

FIG. 2 illustrates an alternative design of a plasma extraction chamber.

FIG. 3 illustrates a multilevel plasma extraction chamber.

FIG. 4 illustrates a dilution chamber.

FIG. 5 illustrates a channel including an internal flow rectification mechanism

FIG. 6 is a flow chart of the general steps of preparing a plasma sample for a differential scanning calorimetry sensor.

FIG. 7 is a 3D simulation showing two chemicals mixing together with inlet velocities of 5 mm/s.

FIG. 8 is a graph of transient simulation of valve actuation showing surface von Mises stresses and surface velocity magnitude at 0 sec and 0.75 sec for a TPU valve with a width of 7.5 μm.

FIG. 9 is a graph illustrating the maximum valve deformation of 3D printer filaments made of PLA, ABS, nylon, PETG, TPU and PDMS.

FIG. 10 is a graph illustrating solid deformation mesh velocity and pressure versus time for an ABS valve.

FIG. 11 is a graph illustrating a comparison of TPU valve deformation in 2D and 3D simulations.

FIG. 12 is a flow chart that graphically outlines the governing equations for fluid-structure interaction.

FIG. 13 is a graph showing the results of serial nitric acid dilutions.

FIG. 14 is a graph showing the results of controlled nitric acid dilutions.

### DETAILED DESCRIPTION

The present invention includes a microfluidic manifold that is capable of separating plasma from whole blood using a three-dimensional structure to extract, and dilute for differential scanning calorimetry (DSC) analysis, or other uses. The microfluidic manifold includes a plasma extraction chamber that separates plasma from whole blood, and a dilution chamber that dilutes the plasma to prepare a diluted plasma sample. The microfluidic manifold may optionally include an internal flow rectification mechanism in the plasma extraction chamber, or the dilution chamber, and/or the connection between the two.

The plasma extraction chamber is designed to eliminate cellular and cellular fragment blood components (for example, white blood cells, red blood cells, and platelets) leading to a plasma sample. The plasma extraction chamber focuses on fully preparing the sample, at the point of use, so it can be used for diagnostics. After a plasma sample is obtained, the dilution chamber portion of the manifold dilutes the plasma sample, and provides a diluted plasma sample. Importantly, the manifold can fully prepare a diluted plasma sample from whole blood, that is at an appropriate concentration for conducting testing on the diluted plasma sample. The microfluidic manifold is disposable and may be used in low-resource areas to provide a cost-effective, fast and simple method to help prepare samples.

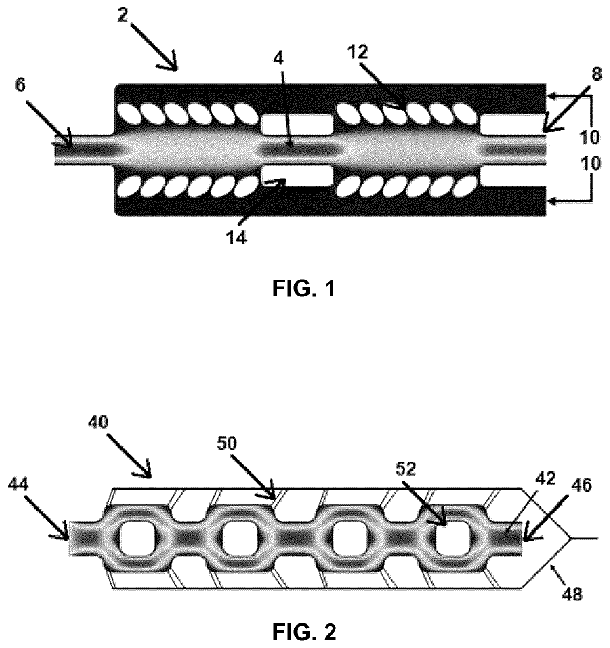

FIG. 1 illustrates an extraction chamber, 2, shown in cross section. The extraction chamber includes a main channel, 4. The main channel includes an inlet, 6 and an outlet, 8. The extraction chamber is configured to allow whole blood to enter the inlet. The extraction chamber includes at least one plasma channel, 10. The plasma channel is fluidly connected to the main channel, via a plurality of side channels, 12. The plasma that is present in the whole blood sample passes through the side channels and enters the plasma channel, 10, leaving cells behind in the main channel. The main channel optionally includes obstructions, 14 to selectively speed up the fluid flow through the channel, as illustrated by the darker portion of the fluid flow. Obstructions may be included along the main channel to increase the velocity of flow regionally and force more of the carrier medium (plasma) into the smaller side channels.

The extraction chamber separates the plasma from large particles (compared to plasma proteins). The large particles will be carried through the main channel, and due to their momentum, will not flow laterally into the side channels. The flow along the side of the main channel is slower than the central portion of the main channel, and by capillary action, the filling of this region of the main channel will provide cell-free plasma via this geometric barrier. The size of the side channels as well as the angle between the main channel and the side channel can be selected to choose the size exclusion of the cellular contents.

FIG. 2 is a schematic of an alternative configuration of an extraction chamber 40, having a main channel, 42. The main channel includes an inlet, 44 and an outlet 46. The extraction chamber includes at least one plasma channel, 48. The plasma channel is fluidly connected to the main channel via a plurality of side channels, 50. The main channel optionally includes obstructions, 52 to selectively speed up the fluid flow through the channel, as illustrated by the darker portion of the fluid flow.

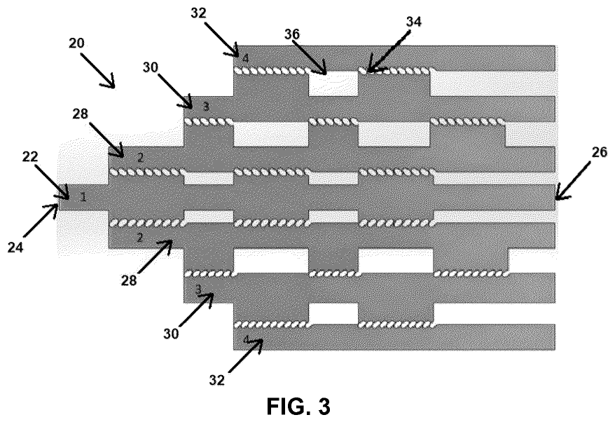

FIG. 3 illustrates a multilevel extraction chamber, 20 shown in cross section. The multilevel extraction chamber includes a main channel, 22, with an inlet, 24 and an outlet 26. The extraction chamber includes at least one plasma channel, 32. The extraction chamber also includes a secondary channel, 28 and optionally a tertiary channel 30. The extraction chamber is configured for whole blood to enter the main channel, 22, where the cellular components remain in the main channel, and plasma passes through a plurality of side channels, 34, into the secondary channel, 28. The plasma passes through additional side channels, 34 until the plasma enters the plasma channel. The main channel and/or the secondary channel may optionally include an obstruction, 36. The multilevel extraction chamber will reduce the amount of stress applied on cells within the sample by performing a multiple level separation. Additional channels may be included in the multilevel extraction chamber. The extraction chamber design incorporated multiple separations to extract all components found in blood. As shown in FIG. 3, Channel 1—main channel. Channel 2—particles <10 μm. Channel 3—particles <6 μm. Channel 4—particles <1 μm.

The main channel of the extraction chamber may have an average diameter of 0.1 mm to 10 mm, preferably the main channel has an average diameter of 0.2 mm to 5 mm, for example, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.25, 2.5, 2.75, 3.0, 3.25, 3.5, 3.75, 4.0, 4.25, 4.5, 4.75, or 5.0 mm. The average diameter of the main channel may not be uniform along the main channel flow path. The average diameter may be reduced by selective placement of obstructions along the flow path. The length of the main channel may be 10 mm to 100 mm, preferably the length is 1, 2, 3, 4, 5, 6, 7, 8, 9, 10, 11, 12, 13, 14, 15, 16, 17, 18, 19, or 20 mm.

There may be a plurality of obstructions along the main channel to speed up portions of the main channel flow path. The main channel may include 1 to 100 obstructions, preferably, 1, 2, 3, 4, 5, 6, 7, 8, 9, 10, 11, 12, 13, 14, 15, 16, 17, 18, 19 or 20 obstructions. The obstructions may reduce the average diameter of a channel by 0.1 mm to 10 mm, preferably by 0.2 mm to 5 mm, for example, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.25, 2.5, 2.75, 3.0, 3.25, 3.5, 3.75, 4.0, 4.25, 4.5, 4.75, or 5.0 mm.

The plasma channel may have an average diameter of 1 to 1000 μm, preferably the plasma channel has an average diameter of 4 to 400 μm, for example 5, 10, 15, 20, 25, 30, 35, 40, 45, 50, 55, 60, 65, 70, 75, 80, 85, 90, 95 or 100 μm. Most preferably the diameter is 30, 31, 32, 33, 34, 35, 36, 37, 38, 39, 40, 41, 42, 43, 44, 45, 46, 47, 48, 49, or 50 μm.

The side channels may have an average diameter of 1 to 200 μm, preferably the side channels have an average diameter of 4 to 100 μm, for example, 5, 10, 15, 20, 25, 30, 35, 40, 45, 50, 55, 60, 65, 70, 75, 80, 85, 90, 95 or 100 μm. Most preferably the average diameter is 5, 6, 7, 8, 9, 10, 11, 12, 13, 14, 15, 16, 17, 18, 19, 20, 21, 22, 23, 24, 25, 26, 27, 28, 29, or 30 μm. In a multilevel plasma extraction chamber the side channels that fluidly connect the main channel and secondary channel may be larger than the side channels that fluidly connect the secondary channel to the plasma channel. The number of side channels that is present in a device may be 2 to 10,000, preferably 5-1000, including 6, 7, 8, 9, 10, 11, 12, 13, 14, 15, 16, 17, 18, 19, 20, 25, 30, 35, 40, 45, 50, 100, 200, 300, 400 and 500. Many channels are included in case clogging occurs in the early channels over the course of the injection of the blood sample. The angle of the side channels in relation to the main channel may be 90 degrees. The angle of the side channel may also be 5, 10, 15, 20, 25, 30, 35, 40, 45, 50, 55, 60, 65, 70, 75, 80, or 85 degrees in relation to the main channel.

The main channel, the plurality of side channels and the plasma channel may optionally be coated with a substance to prevent clogging. For example, a mixture of heparin and glutaraldehyde has been shown to have hydrophilic and anticoagulating properties.

A sample of whole blood or diluted whole blood may be pumped into an extraction chamber by any suitable means, for example a syringe. The sample is injected into an extraction chamber to extract a fractional volume of plasma with a minimal quantity of cellular components. The principles that enable this phenomenon are laminar flow and momentum. The low flow rates in the channels assures that no turbulent mixing will occur, so streamlines form within the main flow channel.

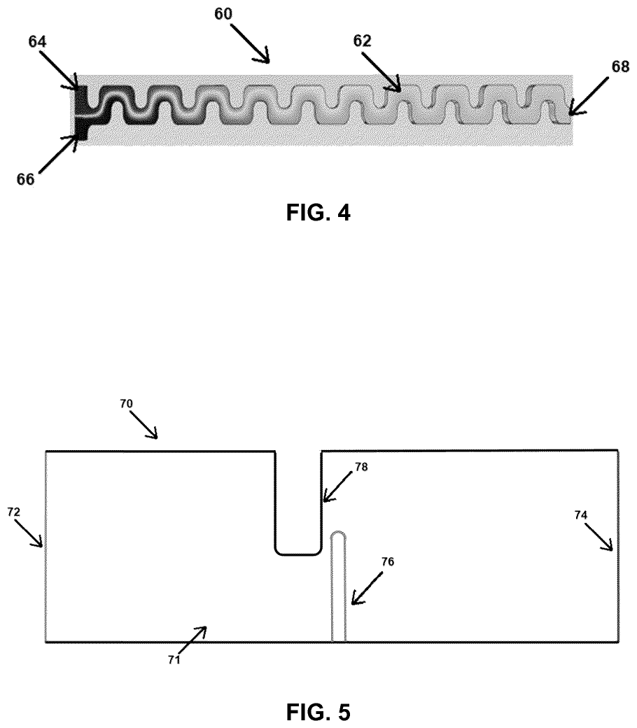

FIG. 4 illustrates a dilution chamber, 60. The dilution chamber includes a dilution channel, 62. A plasma sample enters the dilution channel via a plasma inlet, 64. A dilutant enters the dilution channel via a dilutant inlet, 66. The diluted plasma passes through the dilution channel and exits through the diluted plasma outlet, 68. The dilution channel provides a passive mixing mechanism. The dilution channel may include bends to provide a greater path length than the linear length of the dilution chamber.

The average diameter of the dilution channel may be 20 μm to 50 mm, preferably 25, 30, 35, 40, 45, 50, 60, 70, 80, 90, 100, 150, 200, 300, 400, 500, 600, 700, 800, or 900 μm, or alternatively 1, 2, 3, 4, 5, 6, 7, 8, 9, 10, 11, 12, 13, 14, 15, 16, 17, 18, 19 or 20 mm. The length of the dilution channel may be 1 to 100 mm, preferably 1, 2, 3, 4, 5, 6, 7, 8, 9, 10, 20, 30, 40, 50, 60, 70, 80, 90 or 100 mm.

FIG. 5 illustrates a portion of a channel having an internal flow rectification mechanism, 70 to ensure that fluid flows in only one direction. The channel, 71 includes an inlet, 72 and an outlet, 74. Along the flow path of the channel, an actuated valve, 76 prevents the possibility of backflow in cooperation with a valve stop, 78. The actuated valve allows for fluid movement through the channel from the inlet, 72 to the outlet, 74, but prevents backflow because the actuated valve is held against the valve stop if the pressure is greater on the side of the valve that is closer to the outlet. The internal flow rectification mechanism may be included along the dilution channel of the dilution chamber, between the extraction chamber and the dilution chamber, at inlets and/or at outlets.

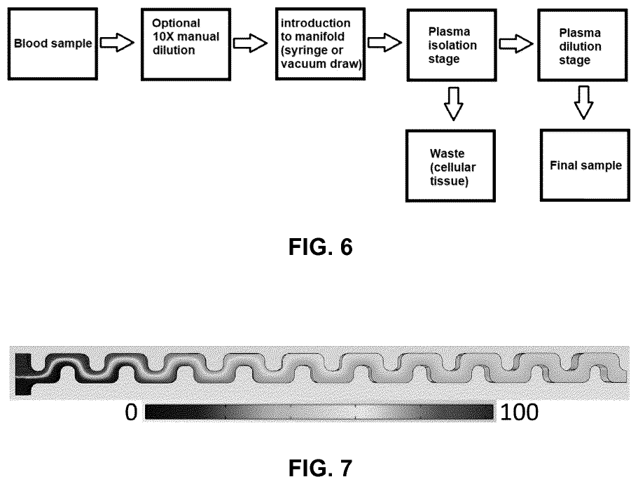

FIG. 6 illustrates a flow chart of a process for preparing a plasma sample. The method includes taking a sample of whole blood, optionally diluting this sample by, for example, 10×, sending this volume through the extraction chamber, then through a final dilution step in the dilution chamber, to obtain diluted plasma, for example 25× diluted plasma. These dilutions should reduce the concentration of blood proteins down to a concentration typical for commercial DSC instrumentation (˜1 mg/mL). The modularity of this setup allows the technology to be applied for specific applications beyond DSC where different dilutions of plasma may be required.

The extraction chamber and dilution chamber may be made of any soft polymer. Examples of suitable polymers include polylactic acid (PLA), acrylonitrile butadiene styrene (ABS), nylon, polyethylene terephthalate glycol-modified (PETG), thermoplastic polyurethane (TPU) and polydimethylsiloxane (PDMS).

The extraction chamber and dilution chamber may be formed using any suitable polymer manufacturing process. Examples of suitable polymer manufacturing processes include 3D printing (also known as additive manufacturing), soft lithography and projection micro-stereolithography (SLA 3D printing). The dilution chamber may also be formed by extrusion or injection molding.

Details of patients from whom samples may be obtained, processing of whole blood samples to obtain plasma for testing, the dilution and other preparation of plasma for testing, and the interpretation of thermograms, may be found in patent application publications, including PCT publication nos. WO 2008/089072, WO 2010/033606 and WO 2011/156658, as well as US Pat. Pub. No. US 2018/0277250, the relevant content of which are hereby incorporated by reference.

### EXAMPLES

### Example 1—Computer Simulations

Flow simulations were performed in COMSOL Multiphysics (Comsol, Inc., Boston, MA). Particle tracing was used to investigate cell separation. Diluted species transport was used to determine the mixing efficiency of two liquids with different concentrations. Fluid-structure interaction (FSI) was used to simulate a check valve with a 3D printed microfluidic system.

Computer simulations of the extraction chamber and dilution chamber were performed. Flow simulations were performed to determine proper extraction chamber geometry and flow configurations. A particle tracing module was used to investigate the separation of 10,000 particles (diameter 6-8 μm, similar to red blood cells) in a fluid that simulates the viscosity of blood. A constriction-expansion channel design focused the flow and increased the cell free (plasma) layer.

A dilution chamber, including a meandering dilution channel, mixed two liquids of differing concentrations (plasma and diluent, typically phosphate buffered saline). Fluid-structure interaction methods were used to simulate a flow-damping check valve within a 3D printed microfluidic channel. FIG. 7 is a 3D simulation showing two chemicals mixing together with inlet velocities of 5 mm/s.

### Example 2—Check Valve Design and Simulation Using Fluid-Structure Interaction

Passive, one-way valves (check valves) are an essential microfluidic feature that facilitates flow rectification. Numerous check valves have been demonstrated in microfluidic systems using PDMS due to its low Young's modulus (0.87 MPa). Recently, 3D printing has become of interest to microfluidics as it accelerates development while reducing time and cost. This study analyzed the range of valve thicknesses necessary to promote flow and deliver precisely controlled volume droplets for five commonly available 3D fused deposition modeling (FDM) printer filament materials.

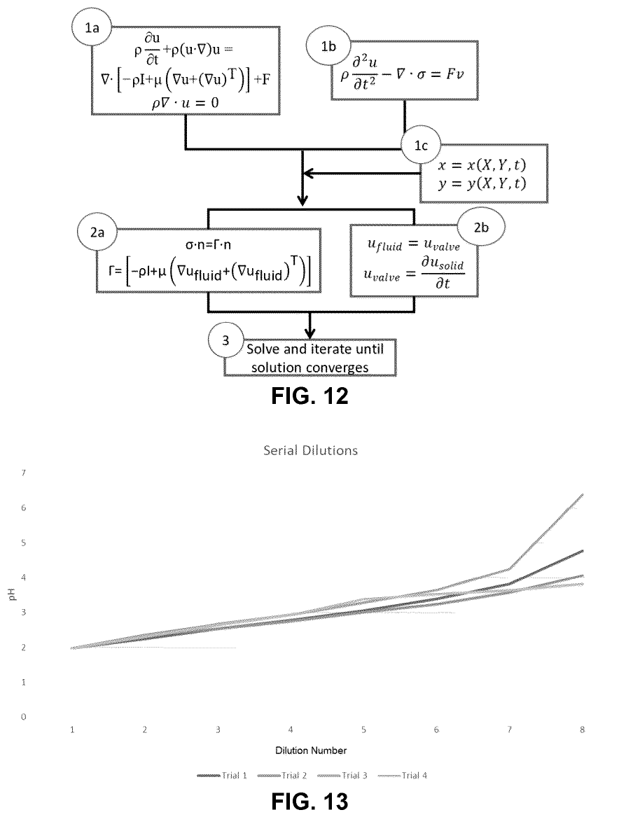

A representative 2D computational fluid dynamics (CFD) model was created in COMSOL Multiphysics® and fully coupled using the fluid-structure interaction (FSI) module. FIG. 12 is a flow chart that graphically outlines the governing equations for FSI. The FSI process includes setting up equations for fluid flow (step 1a), solid deformation (step 1b) and moving mesh (step 1c); applying boundary conditions for fluid forces (step 2a) and fluid velocities (step 2b); and solving the system of equations and iterating until the solution converges.

Five 3D printer filament materials were compared in simulations of valve deformation over a 0.75 second transient period using the material properties of PDMS as a baseline. The velocity profile boundary condition was assigned as fully developed laminar flow entering the channel using the following equation:

$${v}_{i} = {u}_{m e a n} \times 6 \times ( H - Y ) \times \frac{Y}{{H}^{2}} ; {u}_{m e a n} = \frac{U \times {t}^{2}}{\sqrt{{t}^{4} - 0.07 {t}^{2} + 0.0016}}$$

Where vᵢ is velocity; uₘₑₐₙ is centerline velocity; His the height of the channel; Y is the length of the channel; U is inlet velocity; and t is time.

Several valve designs were simulated to observe theoretical deflection for various thicknesses and material properties for several common 3D printer materials. Table 1 below illustrates the properties of the materials tested:

TABLE 1
Material properties

| | ρ | | E |
|---|---|---|---|
| Material | (kg/m³) | ν | (Pa) |
| PLA | 1250 | 0.33 | 3.5 × 10⁹ |
| ABS | 1100 | 0.35 | 2.05 × 10⁹ |
| Nylon | 1130 | 0.39 | 2.95 × 10⁹ |
| PETG | 1260 | 0.40 | 2.0 × 10⁹ |
| TPU | 1100 | 0.40 | 4.5 × 10⁶ |
| PDMS | 0.97 | 0.40 | 0.87 × 10⁶ |

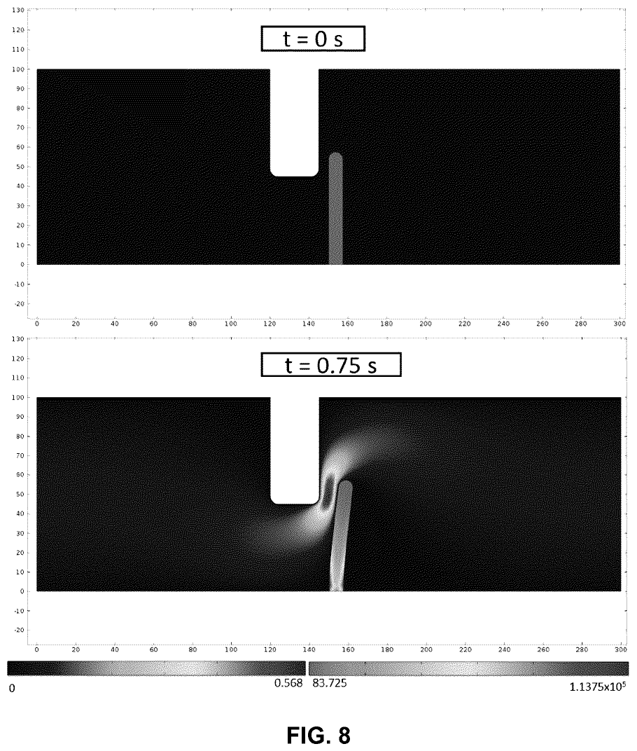

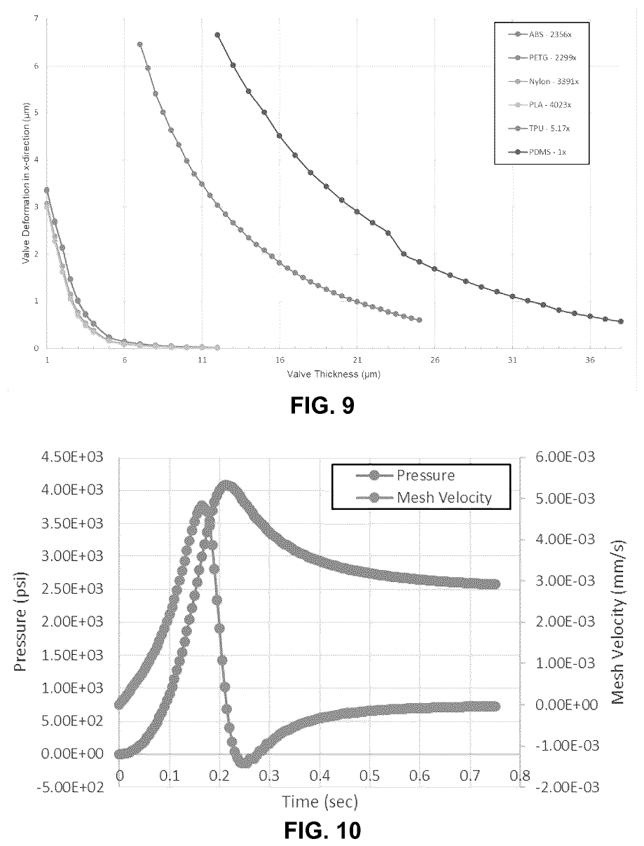

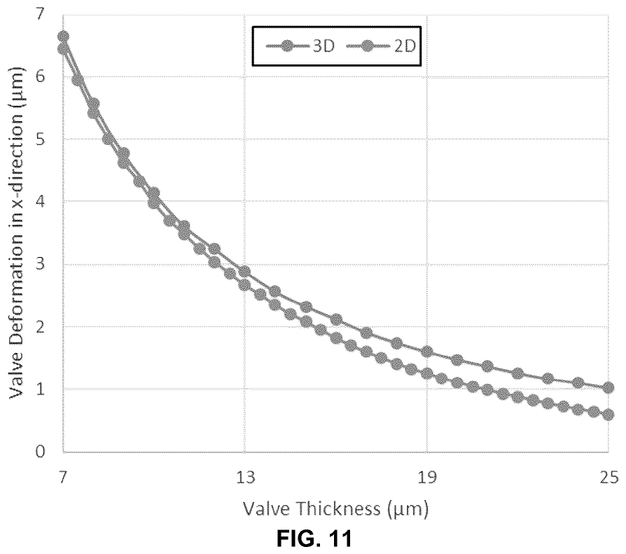

The maximum valve deflection for ABS, nylon, PETG, PLA, and TPU was 3.34, 3.08, 3.37, 3.00, and 6.45 μm, respectively. The simulation resulted in a maximum valve deformation of 6.65 μm for PDMS. The results are illustrated in FIGS. 8-11.

Materials with a Young's modulus close to PDMS allowed valve structures to actuate with adequate forward flow. TPU exhibited similar deformations to PDMS but required smaller valve widths.

### Example 3—Manifold Testing

The simulated designs of the plasma extraction chamber and dilution chamber were exported into solid modeling software and inlets and outlets were added. Each component was printed using polylactic acid (PLA) on a FDM printer. Fluid samples were introduced to the extraction chamber using a syringe pump, controlled using a digital servo coupled to a 3 mL syringe by a linkage. A pressure sensor was incorporated to monitor the amount of pressure entering the microfluidic chamber. The particle tracing module reported less than 1% of particles entered the plasma channels, indicating a high separation efficiency.

A dilution chamber was 3D printed with PLA and tested with 2 different dye solutions. The mixing ratio was altered by changing the inlet velocities. Various dilutions studies were carried out. Yellow and blue dye solutions were mixed and diluted at a range of 8:1 to 1:8 (yellow: blue) using the dilution chamber. Serial and controlled nitric acid dilutions were also performed. Two 3 mL syringes were used. One was filled with DI water while the other was filled 10 mM nitric acid. The syringe pump ran and expelled the liquid from both syringes. The resulting mixture was measured with a pH meter. That mixture was then drawn up (roughly half of it) into a 3 mL syringe for the nitric acid and the other 3 ml syringe was filled with DI water. This process was repeated so a total of 8 dilutions were performed. FIG. 13 is a graph showing the change in pH over 8 serial nitric acid dilutions.

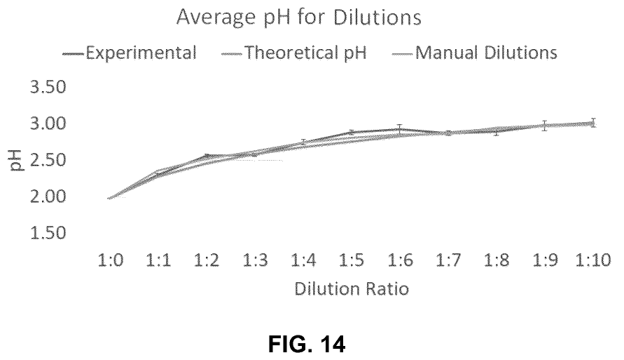

FIG. 14 is a graph showing the change in pH of a series of nitric acid and water mixing experiments. Controlled mixing of different volumes of acid and water was performed to yield a series of acid: water mixtures ranging from mixing ratios of 1:0 acid: water to mixing volumes of 1:30 acid: water. The amount of mixing within the channel was controlled by altering inlet velocity and by adjusting channel inlet geometries. The error bars in the graph represent 1 standard deviation, with a sample size of 3.

The check valve described in Example 2, also referred to as an internal flow rectification mechanism, was also produced using 3D printing. The check valve validated the computer modeling of Example 2. The 3D printer materials with sufficiently low Young's modulus allow sufficient actuation of the valve at approximately 70 μm/s to allow forward flow.

### REFERENCES

1. Jäggi, R. D. et al., “Microfluidic depletion of red blood cells from whole blood in high-aspect-ratio microchannels”, Microfluidics and Nanofluidics, vol. 3, no. 1, pp. 47-53 (2007).
2. Rodriguez-Villarreal, A. I. et al., “High flow rate microfluidic device for blood plasma separation using a range of temperatures”, Lab on a Chip, vol. 10, no. 2, pp. 211-219 (2010).
3. Kersaudy-Kerhoas, M. et al., “Validation of a blood plasma separation system by biomarker detection”, Lab on a Chip, vol. 10, no. 12, pp. 1587-1595 (2010).
4. Tripathi, S. et al., “Blood plasma separation in elevated dimension T-shaped microchannel”, Biomedical Microdevices, vol. 15, no. 3, pp. 415-425 (2013).
5. Lee, M. G. et al., “Inertial blood plasma separation in a contraction-expansion array microchannel”, Applied Physics Letters, vol. 98, no. 25, p. 253702 (2011).
6. Blattert, C. et al., “Separation of blood in microchannel bends”, The 26th Annual International Conference of the IEEE Engineering in Medicine and Biology Society, vol. 1, pp. 2627-2630 (2004).
7. Tripathi, S. et al., “Microdevice for plasma separation from whole human blood using bio-physical and geometrical effects”, Scientific Reports, vol. 6, pp. 1-15, (2016).
8. Prabhakar, A. et al., “A novel, compact and efficient microchannel arrangement with multiple hydrodynamic effects for blood plasma separation”, Microfluidics and Nanofluidics, vol. 18, no. 5-6, pp. 995-1006 (2015).
9. Kersaudy-Kerhoas, M. et al., “Micro-scale blood plasma separation: from acoustophoresis to egg-beaters”, Lab on a Chip, vol. 13, no. 17, pp. 3323-3346 (2013).
10. Tripathi, S. et al., “Passive blood plasma separation at the microscale: A review of design principles and microdevices”, Journal of Micromechanics and Microengineering, vol. 25, no. 8, pp. 1-24 (2015).
11. Yu, Z. T. F. et al., “Microfluidic blood cell preparation: now and beyond”, Small, vol. 10, no. 9, pp. 1687-1703 (2015).
12. Wu, D. et al., “How long can we store blood samples: a systematic review and meta-analysis”, EBioMedicine, vol. 24, pp. 277-285 (2017).
13. Dean, L., “Blood groups and red cell antigens”, National Center for Biotechnology Information, p. 98 (2005).
14. Laser, D. J. et al., “A review of micropumps”, Journal of Micromechanics and Microengineering, vol. 14, pp. R35-R64 (2004).
15. Au, A. K. et al., “Mail-order microfluidics: evaluation of stereolithography for the production of microfluidic devices”, Lab on a Chip, vol. 7, pp. 1294-1301 (2014).
16. Au, A. K. et al., “3D-printed microfluidic automation”, Lab on a Chip, vol. 15, no. 8, pp. 1934-1941 (2015).
17. Lee, Y. S. et al., “3D-printed Quake-style microvalves and micropumps”, Lab on a Chip, vol. 18, no. 8, pp. 1207-1214 (2018).
18. Melvin, A. M. et al., “Modeling 3D printed check valves for microfluidic systems”, 2018 IEEE International Symposium on Signal Processing and Information Technology (ISSPIT), pp. 1-6 (2018).

1. An extraction chamber, comprising:
a main channel,
a plasma channel, and
a plurality of side channels fluidly connecting the main channel to the plasma channel,
wherein each of the plurality of side channels has an average diameter of at most 200 μm at a narrowest cross section.

2. The extraction chamber of claim 1, wherein each of the plurality of side channels has an average diameter of 5-100 μm at the narrowest cross section.

3. The extraction chamber of claim 1, wherein each of the plurality of side channels has an average diameter of 5-30 μm at the narrowest cross section.

4. The extraction chamber of claim 1, wherein the plasma channel has an average diameter of 1-1000 μm at a narrowest cross section.

5. (canceled)

6. The extraction chamber of claim 1, further comprising a secondary channel,
wherein the main channel is fluidly connected to the secondary channel and the secondary channel is fluidly connected to the plasma channel.

7. The extraction chamber of claim 1, wherein the main channel has an average diameter of 0.2-5 mm at a narrowest cross section.

8. The extraction chamber of claim 1, wherein the main channel has an average diameter of 0.3-1.0 mm at a narrowest cross section.

9. The extraction chamber of claim 1, further comprising an obstruction in the main channel.

10. The extraction chamber of claim 1, further comprising a plurality of obstructions in the main channel.

11. The extraction chamber of claim 1, further comprising means for internal flow rectification.

12. The extraction chamber of claim 1, wherein the average diameter of the each of the plurality of side channels at the narrowest cross section is sized to allow plasma to pass through, and does not allow cellular tissue to pass through.

13. A microfluidic manifold, comprising:
the extraction chamber of claim 1, and
a dilution chamber, comprising:
a dilution channel having a first end and a second end,
a plasma inlet on the first end of the dilution channel,
a dilutant inlet on the first end of the dilution channel, and
a diluted plasma outlet on the second end of the dilution channel,
wherein the plasma inlet and dilutant inlet are fluidly connected to the dilution channel, and the diluted plasma outlet is fluidly connected to the dilution channel, and
wherein the extraction chamber is fluidly connected to the dilution chamber.

14. (canceled)

15. The microfluidic manifold of claim 13, wherein the microfluidic manifold comprises at least one polymer selected from the group consisting of polylactic acid (PLA), acrylonitrile butadiene styrene (ABS), nylon, polyethylene terephthalate glycol-modified (PETG), thermoplastic polyurethane (TPU) and polydimethylsiloxane (PDMS).

16. The microfluidic manifold of claim 13, wherein the microfluidic manifold comprises polydimethylsiloxane (PDMS).

17. The microfluidic manifold of claim 13, wherein the extraction chamber, and/or the dilution chamber is coated with a mixture of heparin and glutaraldehyde.

18. The microfluidic manifold of claim 13, wherein the manifold is capable of extracting plasma from less than 5 ml of whole blood.

19. A method of preparing a diluted plasma sample from a whole blood sample, comprising:
pumping a whole blood sample into the extraction chamber of claim 1,
extracting a plasma sample from the whole blood sample, and
diluting the plasma sample.

20. A method of preparing a diluted plasma sample from a whole blood sample, comprising:
pumping a whole blood sample into the microfluidic manifold of claim 13,
extracting a plasma sample from the whole blood sample, and
diluting the plasma sample.

21. The method of claim 20, wherein the sample of whole blood is diluted prior to extracting plasma from the sample of whole blood.

22. A method of preparing a plasma sample, comprising:
pumping a whole blood sample into the microfluidic manifold of claim 13, and
obtaining a diluted plasma sample.

23-25. (canceled)
